(19) United States
(12) Patent Application Publication
(10) Pub. No.: US 2026/0244221 A1
(43) Pub. Date: Aug. 20, 2026

(54) METHOD FOR TRAILER DETECTION AND METHOD FOR CONTROLLING A VEHICLE FUNCTION

(71) Applicant: Robert Bosch GmbH, Stuttgart (DE)

(72) Inventors: Sebastian Muth, Aachen (DE); Kai Buechler, Heilbronn (DE); Matthias Eix, Waeschenbeuren (DE)

(21) Appl. No.: 19/472,386

(22) PCT Filed: Jun. 12, 2024
(86) PCT No.: PCT/EP2024/066220

§ 371 Date: Oct. 3, 2025

(30) Foreign Application Priority Data
Jul. 20, 2023 (DE) 10 2023 206 897.4

(51) Int. Cl. G05D 1/678; B60W 40/12; G05D 1/242

(52) U.S. Cl. CPC G05D 1/678; B60W 40/12; G05D 1/242; B60W 2300/14

(57) ABSTRACT

A method for trailer detection of a trailer of a vehicle. The method includes providing vehicle surroundings sensor data from at least one surroundings sensor which is assigned to the vehicle and acquires at least one surroundings region of the vehicle that at least partly includes the trailer, and creating a trailer model for identifying trailer sensor data in the vehicle surroundings sensor data to be assigned to a trailer including at least a trailer wheel of a trailer axle of the trailer, wherein the trailer model is created based on a classification in which the vehicle surroundings sensor data are categorized into at least one first class that characterizes at least the trailer axle. A method for controlling a vehicle function is also described.

### FIELD

The present invention relates to a method for trailer detection. The present invention also relates to a method for controlling a vehicle function.

### BACKGROUND INFORMATION

Germany Patent Application No. DE 10 2019 220 526 A1 describes a method for determining at least one articulation angle of a vehicle combination including a vehicle and a trailer, in which a position and/or number of wheels of the trailer is ascertained using calculated position information by determining an item of micro-Doppler information based on ascertained radar data and an axle position of axles of the trailer of the vehicle combination is calculated.

### SUMMARY

According to the present invention, a method for trailer detection is provided. According to an example embodiment of the present invention, the method includes: providing vehicle surroundings sensor data from at least one surroundings sensor which is assigned to the vehicle and acquires at least one surroundings region (of the vehicle that at least partly includes the trailer; creating a trailer model for identifying trailer sensor data in the vehicle surroundings sensor data to be assigned to a trailer including at least a trailer wheel of a trailer axle of the trailer; wherein the trailer model is created on the basis of a classification in which the vehicle surroundings sensor data are categorized into at least one first class that characterizes at least the trailer axle.

This allows the vehicle with the trailer to be operated more reliably and more accurately, in particular when turning.

The vehicle can be a motor vehicle, in particular a truck or a bus. The vehicle can be a two-wheeled vehicle, in particular a motorcycle.

A trailer is understood to be a vehicle part that can be decoupled from or permanently connected to the vehicle, can be moved relative to the vehicle, and comprises at least one trailer axle with at least one trailer wheel rolling on a roadway and in particular follows behind the vehicle. The trailer and the vehicle can form a vehicle combination. The trailer can be the rear portion of an articulated bus, a truck trailer, a semi-trailer, or the like. The trailer can be a vehicle trailer that is connected to the vehicle in a decouplable manner via a coupling head on a draw bar.

The surroundings sensor can be, for example, a radar sensor, a camera, a LiDAR sensor, and/or an ultrasonic sensor. The surroundings sensor can provide position information and/or speed information of objects in the surroundings of the vehicle with the vehicle surroundings sensor data.

The vehicle surroundings sensor data can be processed or unprocessed measurement data from the surroundings sensor. The vehicle surroundings sensor data can include position and/or speed information of objects acquired by means of radar reflections in the surroundings region covered by the radar sensor. The vehicle surroundings sensor data can be provided by a plurality of surroundings sensors of the vehicle.

According to an example embodiment of the present invention, the surroundings sensor can be assigned to a driver assistance system. The vehicle surroundings sensor data can also be provided to a driver assistance system. The driver assistance system can process the vehicle surroundings sensor data. The driver assistance system can be a blind spot monitoring system or a turn assist system. The turn assist system can monitor the surrounding area to the right and/or left of the vehicle and detect at least one object moving within it. If a possible collision between the vehicle and the object is calculated, a warning signal can be output to the driver of the vehicle and/or an automated braking function can be triggered. The driver assistance system can be assigned to the vehicle independently of the trailer. The driver assistance system can be configured for operation with and without a trailer.

The surroundings sensor can be disposed on the vehicle.

According to an example embodiment of the present invention, the trailer model is a simulation model, in particular a computer model. The trailer model can estimate the influence of the trailer on the vehicle surroundings sensor data. The influence of the trailer can include a trailer position, at least one trailer dimension, and/or a trailer movement of the trailer.

The classification can include grouping or assignment. The classification can include a further class that characterizes the trailer body.

In a preferred embodiment of the present invention, it is provided that the trailer model is based on an initial trailer estimation model with which an estimating identification of the trailer sensor data is carried out. The trailer estimation model can be based on estimated trailer parameters, possibly including existing vehicle parameters such as the yaw rate or vehicle speed of the vehicle. The trailer parameters can be verified using the created trailer model.

The classification can be carried out on the estimated trailer sensor data.

In a preferred embodiment of the present invention, it is advantageous if the trailer model is created iteratively by using the initial trailer estimation model to classify initial vehicle surroundings sensor data into at least the first class, and processing a plurality of vehicle surroundings sensor data available in time steps in individual calculation steps. The trailer estimation model can be updated after the first calculation step or after multiple calculation steps and stored as a trailer model. The stored trailer model can be updated again after a further calculation step or after multiple further calculation steps and stored as an updated trailer model.

In a specific example embodiment of the present invention, it is advantageous if the plurality of vehicle surroundings sensor data are processed in individual calculation steps by identifying the trailer sensor data in the vehicle surroundings sensor data of a respective time step with the trailer model available for the respective calculation step and classifying them into the first class using the classification, wherein the trailer model is adapted to be applied anew to vehicle surroundings sensor data of a further time step in a subsequent calculation step based on the classification. Vehicle surroundings sensor data aggregated over multiple time steps, or even only vehicle surroundings sensor data from a single time step, can be processed and identified as trailer sensor data in a calculation step.

In a preferred embodiment of the present invention, it is advantageous if a trailer property of the trailer is calculated using the trailer model created based on the classification. This makes it possible to detect the trailer more accurately and estimate its behavior in relation to the vehicle.

In a preferred embodiment of the present invention, it is advantageous if the trailer model calculates a trailer property when a minimum number of calculation steps and/or a minimum number of trailer sensor data is reached.

The trailer property can be a number of trailer axles of the trailer. The trailer property can be a trailer position relative to the vehicle, for example a lateral position and/or a rotated position, in particular an articulation angle. The rotated position can vary during a turning movement about an axis of rotation formed by the trailer hitch of the vehicle. The lateral position can vary during a braking operation of the overrun brake of the trailer. The trailer property can be a trailer dimension, for example a trailer length and/or a trailer width. The trailer property can be a trailer axle position relative to the trailer or the vehicle. The trailer property can be a wheelbase of at least one trailer axle. The trailer property can be an average wheelbase of the multi-axle trailer.

In a preferred embodiment of the present invention, it is provided that the first class includes one or more trailer wheels of a trailer axle of the trailer. The trailer sensor data can include all of the trailer wheels of all of the trailer axles of the trailer. Each trailer axle can be assigned its own class.

In a preferred embodiment of the present invention, it is provided that the trailer comprises at least one further trailer axle and the classification includes a further class that characterizes at least the further trailer axle. The first class can characterize a first trailer axle, for example, and a further class can characterize a further trailer axle.

In a specific example embodiment of the present invention, it is advantageous if the trailer model includes a trailer movement of the trailer depending on at least one movement property of the vehicle. The trailer model can characterize the trailer movement depending on the movement property of the vehicle. The movement property can be a yaw rate and/or a speed of the vehicle.

The classified trailer sensor data comprising the first class can be processed in an evaluation. The trailer model can be created and/or the trailer property can be calculated depending on the evaluation. If the number of trailer axles is to be ascertained as a trailer property, for instance, there are a number of different possible options for evaluating the trailer sensor data and, when using a radar sensor as a surroundings sensor, the reflection points. The evaluation can, for example, be based on a frequency distribution of the reflection points assigned to the trailer wheels specified by the trailer sensor data in a polar coordinate system with the coupling point as the coordinate origin.

Alternatively or additionally, the speed information of the reflection points can be used and plotted in a vr-r graph, in which the radial relative speed vr is stated as a function of the distance r to the coupling point or the surroundings sensor. The number of trailer axles can be calculated using a cluster search.

According to an example embodiment of the present invention, the reflection points can alternatively or additionally be shown in a histogram as a function of the distance to the radar sensor or the distance to the coupling point. A variety of methods can be used to determine the number of trailer axles in this histogram. A peak finder algorithm could be used, for instance. If the trailer axles appear in the radar reflections with different frequencies, however, it may be useful to preprocess the trailer sensor data, for example by scaling the frequencies with the distance.

The present invention further provides a method for controlling a vehicle function. The vehicle function can be assigned to a driver assistance system. The driver assistance system can be controlled depending on the trailer model.

The vehicle function can be a user display, for example on a display in the vehicle. The user display can show a more accurate image of the trailer. The user display can be controlled depending on the trailer model.

In a preferred embodiment of the present invention, it is provided that the vehicle surroundings sensor data assigned to the trailer are identified as trailer sensor data in the vehicle surroundings sensor data by using the trailer model. The trailer sensor data can be classified by using the trailer model.

In a special example configuration of the present invention, it is advantageous if the control of the vehicle function is carried out depending on the vehicle surroundings sensor data cleaned of the trailer sensor data. The control of the vehicle function can thus be carried out such that it is unaffected by the presence of the trailer in the vehicle surroundings sensor data.

The present invention also relates to a vehicle control device for controlling a vehicle function according to one of the above-described methods.

Further advantages and advantageous example embodiments of the present invention will emerge from the description of the figures and the figures.

### BRIEF DESCRIPTION OF THE DRAWINGS

The present invention is described in detail in the following with reference to the figures.

FIG. 1 shows a method for method for trailer detection in a specific example embodiment of the present invention.

FIG. 2 shows a method for controlling a vehicle function of the vehicle in a specific example embodiment of the present invention.

FIG. 3 shows a schematic illustration of a vehicle and radar reflection points from example trailer sensor data.

FIG. 4 shows an illustration of reflection points from measured trailer sensor data.

FIG. 5 shows a speed distribution of measured trailer sensor data.

FIG. 6 shows a frequency distribution of measured trailer sensor data.

### DETAILED DESCRIPTION OF EXAMPLE EMBODIMENTS

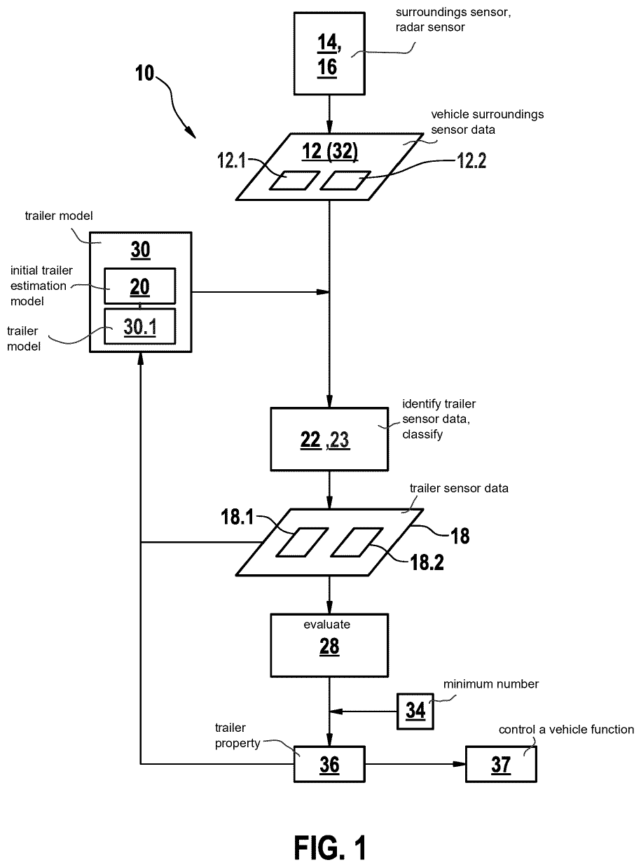

FIG. 1 shows a method for method for trailer detection in a specific example embodiment of the present invention. The method for trailer detection 10 of a trailer of a vehicle initially comprises providing vehicle surroundings sensor data 12 from a surroundings sensor 14 which is assigned to the vehicle and acquires at least one surroundings region of the vehicle that at least partly includes the trailer. The surroundings sensor 14 is a radar sensor 16, for instance, that provides position and speed information about the acquired surroundings of the vehicle in the surroundings region. The vehicle surroundings sensor data 12 preferably include position and speed information of objects acquired by means of radar reflections in the surroundings region covered by the radar sensor 16.

The vehicle surroundings sensor data 12 assigned to the trailer, i.e. the vehicle surroundings sensor data 12 resulting from radar reflections of the trailer, are identified as trailer sensor data 18 in the vehicle surroundings sensor data 12 by using an initial trailer estimation model 20. The trailer estimation model 20 can preferably incorporate estimated or known trailer parameters of the trailer, which are in turn obtained from information of the vehicle, such as vehicle speed and/or yaw rate, for example.

Identifying 22 the trailer sensor data 18 includes classifying 23 in particular the trailer sensor data 18 assigned to a trailer axle into at least a first class 18.1 and/or the trailer sensor data assigned to the trailer body into a second class 18.2. The trailer sensor data 18 assigned to the ground reflections can also form a separate further class.

The trailer sensor data that have been identified in this manner and preferably classified into the first and second classes 18.1, 18.2 are then processed in an evaluation 28 and, depending on the evaluation 28, the trailer model 30 is created based on the trailer estimation model 20.

The trailer model 30 is preferably created iteratively in individual calculation steps with a plurality of vehicle surroundings sensor data available in time steps by classifying initial vehicle surroundings sensor data 12.1 into at least the first and second classes 18.1, 18.2 using the initial trailer estimation model 20, creating the trailer model 30.1 available for this calculation step based on this, and processing the vehicle surroundings sensor data 12.2 assigned to at least one further time step in a subsequent calculation step with the trailer model 30.1 by identifying and reclassifying the associated trailer sensor data 18 and adapting the trailer model 30.1 to be applied anew to vehicle surroundings sensor data 12 of a further time step in a subsequent calculation step based on the classification, as a result of which the trailer model 30 is updated and created incrementally in repeated runs.

When a minimum number 34 of calculation steps and/or a minimum number of trailer sensor data 18 is reached, a trailer property 36 of the trailer, for example an axle number of the trailer axles, is calculated. This calculated trailer property 36 can then be used to update the trailer model 30. This makes it possible to incrementally improve the trailer model 30.

The trailer property 36 can in turn be used to control 37 a vehicle function, for example, a driver assistance system. The performance of the driver assistance system when turning, for example, can be improved.

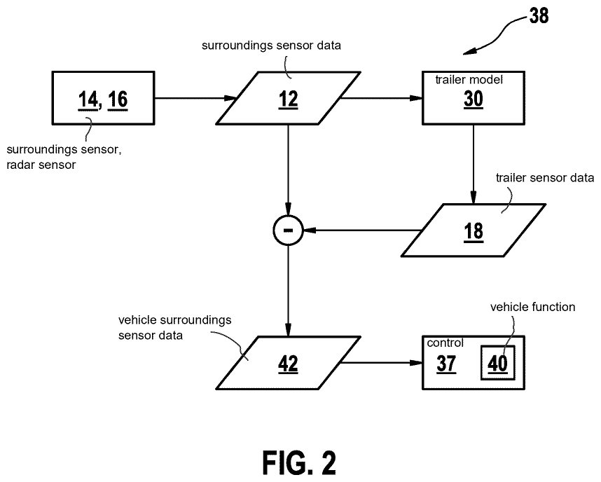

FIG. 2 shows a method for controlling a vehicle function of the vehicle in a specific embodiment of the present invention. The method for controlling 38 a vehicle function 40 of a vehicle with a trailer includes recording vehicle surroundings sensor data 12 from a surroundings sensor 14 which is assigned to the vehicle and acquires at least one surroundings region of the vehicle that at least partly includes the trailer. The surroundings sensor 14 can be a radar sensor 16. The vehicle surroundings sensor data 12 can show radar reflections of objects in the surroundings of the vehicle.

By providing the trailer model 30 of the trailer of the vehicle created using the method for trailer detection of FIG. 1, for example, the vehicle function 40 is controlled depending on the trailer model 30. For this purpose, in particular the vehicle surroundings sensor data 12 assigned to the trailer are identified and classified as trailer sensor data 18 in the vehicle surroundings sensor data 12 by using the trailer model 30, and vehicle surroundings sensor data 42 cleaned of the trailer sensor data 18 are output.

The control 37 of the vehicle function 40, for example the control 37 of a driver assistance system, is then carried out depending on the cleaned vehicle surroundings sensor data 42. The driver assistance system can thus function even when operating with a trailer. The trailer sensor data 18 show the radar reflections that are assigned to the trailer and can be filtered out of the vehicle surroundings sensor data 12, i.e. the total radar reflections of the surroundings of the vehicle acquired by the radar sensor 16, and the driver assistance system can in particular be operated as if no trailer were present.

The trailer model 30 is in particular used alongside position information and speed information (in particular, the micro-Doppler information) to detect the axle position of the trailer axle(s) of the trailer. Trailer parameters such as the wheelbase and the hitch position are continuously estimated using the position information of the trailer axle(s) in order to update the trailer model 30. The radar detections, which can be assigned to the trailer model 30 with a specific probability, are filtered so that no objects from these radar detections are included in the subsequent control 37 of the vehicle function 40.

The interaction of the trailer model 30 and the vehicle surroundings sensor data 12 results, for instance, in reliable assignment and filtering of trailer-based radar detections in every driving situation of the vehicle with a trailer (in particular when driving straight ahead or turning). This enables the control 37 of the vehicle function 40, preferably the driver assistance function, when towing a trailer and excludes erroneously perceived objects in the surroundings resulting from trailer-based radar detections.

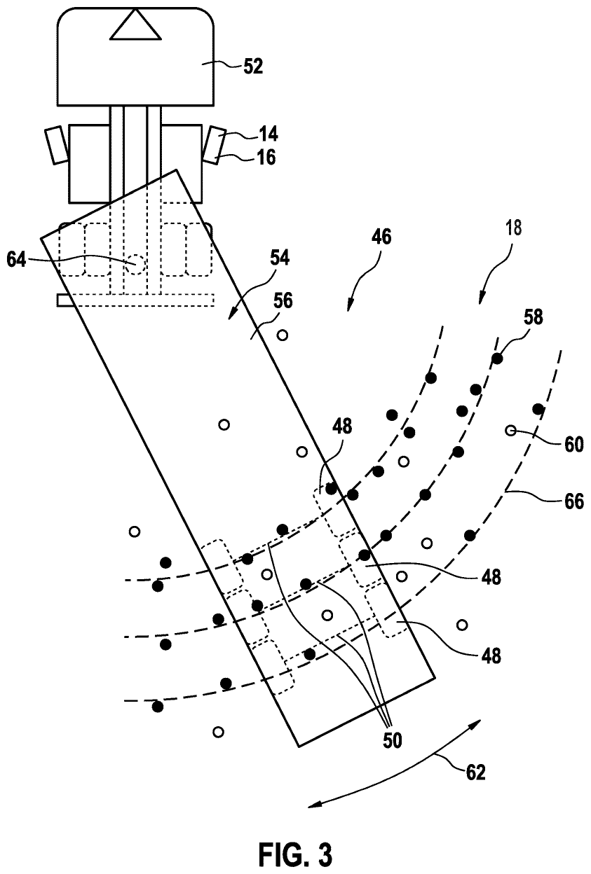

FIG. 3 shows a schematic illustration of radar reflection points from example trailer sensor data. The trailer sensor data 18 can include the trailer wheels 48 of the three trailer axles 50 of the trailer 54 connected to the vehicle 52, and the trailer body 56, acquired in the surroundings region 46 by the surroundings sensor 14, here the radar sensor 16, disposed on the vehicle 52. The trailer sensor data 18 can be classified as radar reflection points 58 of the trailer wheels 48 and reflection points 60 of the trailer body 56.

The trailer model can include a trailer movement 62 of the trailer 54, for example a turning movement about the coupling point 64 formed by the trailer hitch based on at least one movement property of the vehicle 52.

If the trailer 54 moves around the coupling point 64, the articulation angle of the trailer 54 changes, and the radar reflections of the trailer wheels 48 are distributed in circular paths 66 around the coupling point 64 of the trailer 54. The position of the radar reflection points 58, 60 assigned to the trailer wheels 48 is stored during the evaluation of the trailer sensor data obtained from the vehicle surroundings sensor data available over multiple time steps, converted into a polar coordinate system with its origin at the coupling point 64 of the trailer 54, and displayed as a histogram, for example, (frequency plotted to radius).

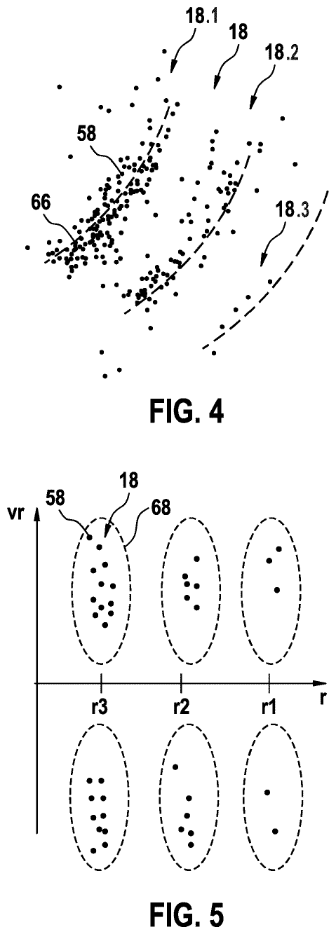

FIG. 4 shows an illustration of reflection points from measured trailer sensor data. The measured trailer sensor data 18 result from a short measurement over a measuring time of just few minutes of a vehicle combination consisting of a tractor unit as shown in FIG. 3 and a three-axle semi-trailer trailer. The point groups of the three trailer axles of the trailer can be seen, and also that the frequency of measured radar reflections, shown here as radar reflection points 58 of the trailer wheels, decreases for further away trailer axles.

For the sake of clarity, the circular paths 66 of the trailer wheels are indicated by solid lines. The trailer sensor data in the form of point groups in this coordinate system can be classified into a first class 18.1 corresponding to the first trailer axle, a second class 18.2 corresponding to the second trailer axle, and a third class 18.3 corresponding to the third trailer axle.

FIG. 5 shows a speed distribution of measured trailer sensor data. The trailer sensor data 18 can be evaluated via a group search in a vr-r graph, in which the radial relative speed vr is specified as a function of the distance r to the coupling point. Each radar reflection point 58 is acquired by the radar sensor with a radial relative speed vr. The stored radar reflection points 58 are plotted as relative speeds of each radar reflection point 58 as a function of the distance r to the coupling point (or pivot point). The point groups 68 that belong together are indicated by dashed regions. The number of these point groups 68, corresponding to the classes identified by a classification, can be used to ascertain the sought number of trailer axles at the distances r1, r2 and r3.

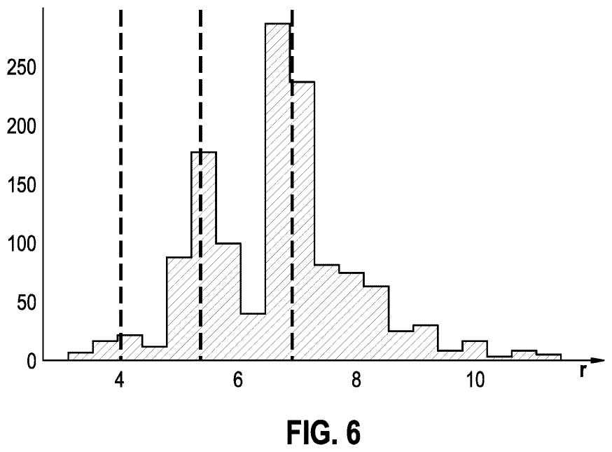

FIG. 6 shows a frequency distribution of measured trailer sensor data. The number of trailer axles can be estimated directly from the histogram as a frequency distribution depending on the distance r to the radar sensor. The example histogram reflects the wheelbase estimates from individual radar reflection points for a vehicle combination consisting of a semi-tractor and a three-axle semi-trailer as a trailer. The trailer sensor data entered in the histogram as reflection points originate from measured vehicle surroundings sensor data. The actual axle positions of the trailer axles are indicated as vertical dashed lines. The different frequency distributions of the measured reflections of the individual trailer axles are clearly visible.

A variety of methods can be used to determine the number of trailer axles in this histogram. A peak finder algorithm could be used, for instance. Because the trailer axles appear in the radar reflections with different frequencies, however, it is useful here to preprocess the trailer sensor data, for example by scaling the frequencies with the distance r from the radar sensor.

The results of the different evaluation methods can be combined with one another. Simple weighting or more complex methods such as a type of filter or machine learning are possible here.

Since the stored trailer model is based in particular on a single-track model, estimating the axle positions makes it possible to better estimate the wheelbase for the trailer model. In the case of non-equidistant trailer axles or when the wheelbase estimate is distorted by the frequency of visibility of the individual trailer axles, for instance, a more precise calculation of the model is possible.

1-10. (canceled)

11. A method for trailer detection of a trailer of a vehicle, the method comprising the following steps:
providing vehicle surroundings sensor data from at least one surroundings sensor which is assigned to the vehicle and acquires at least one surroundings region of the vehicle that at least partly includes the trailer; and
creating a trailer model for identifying trailer sensor data in the vehicle surroundings sensor data to be assigned to a trailer including at least a trailer wheel of a trailer axle of the trailer;
wherein the trailer model is created based on a classification in which the vehicle surroundings sensor data are categorized into at least one first class that characterizes at least the trailer axle.

12. The method for trailer detection according to claim 11, wherein the trailer model is based on an initial trailer estimation model with which an estimating identification of the trailer sensor data is carried out.

13. The method for trailer detection according to claim 12, wherein the trailer model is created iteratively by:
using the initial trailer estimation model to classify initial vehicle surroundings sensor data into at least the first class; and
processing a plurality of vehicle surroundings sensor data available in time steps in individual calculation steps.

14. The method for trailer detection according to claim 13, wherein the plurality of vehicle surroundings sensor data are processed in each respective calculation step of individual calculation steps by:
identifying the trailer sensor data in the vehicle surroundings sensor data assigned to a respective time step with the trailer model available for the respective calculation step, and
classifying the trailer senor data into the first class using the classification;
wherein the trailer model is adapted to be applied anew to vehicle surroundings sensor data of a further time step in a subsequent calculation step based on the classification.

15. The method for trailer detection according to claim 11, wherein a trailer property of the trailer is calculated using the trailer model created based on the classification.

16. The method for trailer detection according to claim 15, wherein the trailer model is created iteratively by:
using the initial trailer estimation model to classify initial vehicle surroundings sensor data into at least the first class; and
processing a plurality of vehicle surroundings sensor data available in time steps in individual calculation steps;
wherein the trailer model calculates the trailer property when a minimum number of calculation steps and/or a minimum number of trailer sensor data is reached.

17. The method for trailer detection according to claim 15, wherein the trailer property is a number of trailer axles of the trailer.

18. The method for trailer detection according to claim 11, wherein the trailer includes at least one further trailer axle and the classification includes a further class that characterizes at least the further trailer axle.

19. A method for controlling a vehicle function of a vehicle with a trailer, comprising the following steps:
recording vehicle surroundings sensor data from a surroundings sensor which is assigned to the vehicle and acquires at least one surroundings region of the vehicle that at least partly includes the trailer;
creating a trailer model of a trailer of the vehicle by:
providing vehicle surroundings sensor data from at least one surroundings sensor which is assigned to the vehicle and acquires at least one surroundings region of the vehicle that at least partly includes the trailer, and
creating a trailer model for identifying trailer sensor data in the vehicle surroundings sensor data to be assigned to a trailer including at least a trailer wheel of a trailer axle of the trailer,
wherein the trailer model is created based on a classification in which the vehicle surroundings sensor data are categorized into at least one first class that characterizes at least the trailer axle; and
controlling the vehicle function depending on the trailer model.

20. The method for controlling a vehicle function according to claim 19, wherein the vehicle surroundings sensor data assigned to the trailer are identified as trailer sensor data in the vehicle surroundings sensor data by using the trailer model, and the control of the vehicle function is carried out based on vehicle surroundings sensor data cleaned of the trailer sensor data.
